(19) United States
(12) Patent Application Publication
(10) Pub. No.: US 2003/0024812 A1
(43) Pub. Date: Feb. 6, 2003

(54) Solid-state reference electrode system

(76) Inventor: Steven J. West, Hull, MA (US)

Correspondence Address: BANNER & WITCOFF, LTD., 28 STATE STREET, 28th FLOOR, BOSTON, MA, 02109, US

(21) Appl. No.: 09/796,103

(22) Filed: Feb. 28, 2001

(51) Int. Cl. G01N 27/414

(52) U.S. Cl. 204/416; 204/435

(57) ABSTRACT

Disclosed is an electrochemical cell containing two or more electrodes wherein the half-cell potential of at least one electrode is determined by the concentration of a specific ion anticipated to be present in all test solutions, said ion concentration being measured in the cell by a first electroanalytical technique that does not depend on a known reference electrode potential, such that said electrode, its half-cell potential being calculable from the measured ion concentration, can then serve as a reference electrode in one or more subsequent electroanalytical techniques that do depend on a known reference electrode potential, said subsequent technique or techniques being carried out in the same cell.

### BACKGROUND OF THE INVENTION

Reference electrodes are a fundamental component in electroanalytical chemistry. The greatest demands for accuracy and stability in a reference electrode are found in potentiometric measurements which include pH, other ion-selective electrode (ISE) techniques, and “redox” or oxidation-reduction potential (ORP). A reference half-cell is an electrode with a half-cell potential that is known not to vary as the parameter of interest in the sample varies. In pH or ISE work, it is the activity or concentration of a specific ion that is the parameter of interest, while ORP is usually determined by two or more ionic or non-ionic species in the sample. Reference electrodes are also required in voltammetry, another branch of electroanalytical chemistry. In voltammetry, the requirement for accuracy and stability of the reference electrode is often not as stringent as in potentiometry. In some voltammetric techniques such as chronopotentiometry, discussed below, the potential of the reference electrode need not be known, because in this technique it is the variation in the half-cell potential of the working electrode as a function of time that enables the determination of an analyte ion concentration.

Reference electrodes generally consist of an internal ion-selective or redox-sensitive element, perhaps as simple as a wire, that is maintained in contact with an electrolyte containing a fixed concentration of the ion, ions, or other species that determine its potential. The internal electrolyte contacts the test solution at a point called the liquid junction. The liquid junction completes the measuring circuit without allowing bulk mixing of the internal electrolyte and test solution, since such mixing would compromise the integrity of both. The internal electrolyte and liquid junction together are called a “salt bridge”. The liquid junction can be a simple orifice that is too small to permit significant intermixing during the course of a measurement or it may consist of a porous, wettable, non-permselective material.

A problem that often arises in designing electroanalytical cells is that the reference electrode tends to be the most complex component and imposes limits in terms of size, temperature and pressure range, portability, maintenance, and reliability. For example, a typical chloride ISE consists of chloride-sensitive, solid-state element that can be configured in numerous ways. It can be made small and has a very long lifetime in most applications. A typical reference electrode may be based on that very same chloride-sensitive element, but must also accommodate an internal electrolyte with invariant chloride content and a liquid junction. The reference electrode system is thus bigger and more complex than the chloride ISE, is subject to contamination when sample ions diffuse through the junction into the internal electrolyte, and may have limited life due to compromise of electrolyte by contamination with, or loss of, ions or water. Moreover, solutions are generally inconvenient-they can freeze, leak, evaporate, expand, contract, and add to the mass and volume of components.

### PRIOR ART

It has been the goal of many investigators to eliminate the liquid-junction reference electrode from measuring cells—in other words, to develop all solid-state systems without salt bridges. However, there is basic electrochemistry theory suggesting that a true solid-state potentiometric reference electrode may be an impossibility—the potential at the solid-state sensing element must be established by some component or components in the test solution and, if variations in concentration occur, the potential will change. Even the best liquid junction, one containing a high concentration of equitransferent electrolyte, is not immune to potential shifts in some solutions, for example, strong acids or bases.

Much of the work toward a solid-state potentiometric reference electrode has originated in the field of micro-fabricated chemical sensors. The primary relevant example of such a chemical sensor is the Ion-Selective Field-Effect Transistor (ISFET) sensitive to pH. This is an all sold-state device that is manufactured on silicon wafers using standard micro-electronic fabrication techniques. However, its use requires a potentiometric reference electrode. The desire to manufacture a reference electrode as part of the same device using the same micro-fabrication techniques has driven research into reference systems where the salt bridge is eliminated.

One approach, that of Berveld, et al. (Bergveld, P. et al., Sensors and Actuators, 18 (1989), 309-327), has been to modify a pH ISFET such that it loses its sensitivity to pH and can therefore be used as a reference in a differential measurement circuit. Some degree of success has been achieved but only under very limited conditions. Yamaguchi, et al. (U.S. Pat. No. 5,066,383 (1991)) describe a laminated film and Schwiegk, et al. (U.S. Pat. No. 5,182,005 (1993)) describe a polyglutamate film that are claimed to provide a pH-insensitive interface for use as a reference electrode. Yamaguchi and Schwiegk provide performance in a limited set of solution matrices. Collins (Collins, S. D., Sensors and Actuators B, 10 (1993), 169-178) performed a theoretical analysis of this approach of modifying or inventing an interface that does not respond to pH or other ionic activities and concluded:

“From an analysis of electrochemical charge transfer, the most likely solution, if possible, for a solid-state reference electrode appears to be a non-blocked interface at equilibrium where the partition coefficients for all ions with dominant heterogeneous exchange currents (and preferably all ions) are equal. Although no specific violation of first principles could be found to contradict the possible existence of an interface which partitions all cations and all anions equally, such an interface appears unlikely . . . . The present effort to engineer a solid-state reference electrode based on a completely ion-blocked interface is not a viable solution . . . such an interface is guaranteed to respond . . . . to some solution ion . . . and adds deleterious noise susceptibility and interference . . . ”.

### SUMMARY OF THE INVENTION

Sometimes in practice, in order to eliminate the inconvenience of liquid junction systems, solid-state ISEs are used as reference electrodes by adding a known amount of the ion sensed by the ISE to all sample and calibration solutions. In this manner, provided it is unaffected by variations in the parameter of interest, the solid-state ISE fulfills the requirement of a reference electrode to have a potential that is known in all solutions tested. For example, if a sample contained chloride and its concentration were known, then a solid-state chloride ISE could serve as a reference half-cell for electrochemical measurements in that sample. In effect, the sample solution would be serving the same function as the salt bridge solution of a conventional reference. The measurement system would then be simpler, more reliable, and longer-lived than one with a conventional reference electrode because the liquid junction and internal electrolyte could be eliminated.

It's worth pointing out that certain ISEs that cannot strictly be termed “solid-state” could serve in the capacity described for the solid-state chloride ISE above and the goal of eliminating the salt bridge and liquid junction would still be accomplished. In a recent publication by West, at al. (West, et al., American Laboratory, 31, 20 (1999), 48-54), polymer-membrane, lithium-sensitive ISEs were used as reference electrodes in test solutions to which lithium ion was added. The lithium ISEs described not only had polymer membranes but internal electrolyte as well. The internal electrolyte in this case was isolated from the sample by the membrane (no liquid junction). In the context of this document, the term solid-state is not intended to exclude cases where the liquid junction is eliminated by the use of an ISE that is in its entirety not strictly a solid-state device.

The concept of using an ISE as reference electrode in test solutions where its target analyte ion is present in known concentration has been introduced above. In these cases, the analyte ion concentration is known because it is intentionally added to the test solutions. The present invention is a variation on this concept.

Thus, in one embodiment, the present invention is directed to an electrochemical cell containing two or more electrodes wherein the half-cell potential of at least one electrode is determined by the concentration of a specific ion anticipated to be present in all test solutions, said ion concentration being measured in the cell by a first electroanalytical technique that does not depend on a known reference electrode potential, such that said electrode, its half-cell potential being calculable from the measured ion concentration, thereafter serves as a reference electrode in one or more subsequent electroanalytical techniques that do depend on a known reference electrode potential, said subsequent technique or techniques being carried out in the same cell.

In another embodiment, the present invention is directed to an electrochemical cell as set forth above, wherein the electrode with half-cell potential determined by a specific ion is a chloride ion-selective electrode (ISE), the ion that determines its potential is chloride ion, and the test solutions are either standardizing solutions of known composition or sample solutions of unknown composition, but where all said solutions are known to contain chloride ion.

In another embodiment, the present invention is directed to an electrochemical cell as set forth above, wherein the first electroanalytical technique, that does not depend on a known reference electrode potential, is chronopotentiometry.

In another embodiment, the present invention is directed to an electrochemical cell as set forth above, wherein one of the subsequent electrochemical techniques that does depend on a known reference potential is potentiometry.

In another embodiment, the present invention is directed to an electrochemical cell as set forth above, wherein the working electrode is silver and the ion determined by chronopotentiometry is chloride ion.

In another embodiment, the present invention is directed to an electrochemical cell as set forth above, wherein the silver working electrode, because the anodic deposition of chloride on the silver surface during chronopotentiometry renders that surface ion-selective for chloride, also serves as reference electrode for subsequent techniques.

In another embodiment, the present invention is directed to an electrochemical cell as set forth above, wherein ORP, pH, or other specific ions are the parameters measured by potentiometry.

In another embodiment, the present invention is directed to an electrochemical cell comprising at least one ion-selective electrode, the potential of which is determined by the concentration of a specific ion, anticipated to be present in all test solutions, said ion concentration being determined in the cell by a first electroanalytical technique carried out in the same cell. Preferably, the electrode is a chloride electrode. Preferably, the ion that determines its potential is chloride, and the test solutions are standardizing solutions all of which contain chloride ion.

Preferably, the technique for determining chloride is chronopotentiometry, the working electrode is a silver wire, and a chloride ion selective electrode serves as a reference electrode, the potential of which is initially unknown, but only until such time as the technique is completed, when the chloride ion concentration and therefore chloride electrode potential become known. Preferably, the chloride electrode, its potential having been determined by chronopotentiometry, serves as reference electrode for a different electroanalytical technique, preferably a direct potentiometric measurement such as pH, ORP, or other ISE measurement.

### BRIEF DESCRIPTION OF THE DRAWINGS

FIG. 1 shows a series of chronopotentiograms and their first derivatives for 5 concentrations of chloride from 1 to 10 mM, each run twice.

FIG. 2 is a typical chloride calibration curve obtained by plotting against the chloride concentration the time elapsed to the chronopotentiometric inflection point as indicated by the maximum in the first derivative.

### DETAILED DESCRIPTION OF THE PREFERRED EMBODIMENTS

As described above, the present invention most preferably comprises an electrochemical cell containing two or more electrodes wherein the half-cell potential of at least one electrode is determined by the concentration of a specific ion anticipated to be present in all test solutions, said ion concentration being measured in the cell by a first electroanalytical technique that does not depend on a known reference electrode potential, such that said electrode, its half-cell potential being calculable from the measured ion concentration, can then serve as a reference electrode in one or more subsequent electroanalytical techniques that do depend on a known reference electrode potential, said subsequent technique or techniques being carried out in the same cell.

The fundamental teaching of the subject invention is this: If an ion for which an ISE exists can be determined accurately in a test solution by means of an electrochemical cell without liquid junction, that ISE can then serve as reference electrode for other measurements carried out in that cell. Consider a cell that contains four electrodes: a glass half-cell pH electrode, a platinum wire, a silver wire, and a solid-state chloride ISE (referred to hence as Embodiment 1). The electrodes are immersed in a water sample to be tested. The electrodes are connected to electronic circuitry that is designed to carry out the following sequence of steps:

1. A first electroanalytical technique, chronopotentiometry, is carried out using the silver wire, the chloride ISE, and the platinum wire as the working, reference, and counter electrodes respectively. Chronopotentiometry is capable of determining chloride to an accuracy of 1 to 5% in the range of 0.0005 to 0.025 molar ((Peters, D. G., Kinjo, A., Analytical Chemistry, 41, 13 (1969), pp. 1806-1810) and does not require that the potential of the reference electrode be known. All natural water samples contain chloride in the aforementioned range, as do the wide majority of liquids on Earth.

2. Having determined the chloride concentration by chronopotentiometry, thus permitting calculation or “looking up” of the chloride ISE potential at that chloride concentration, the chloride ISE may now serve as a reference electrode. The electronic circuitry can switch from chronopotentiometry to a subsequent electroanalytical technique, for example, potentiometry (or another technique), in which the chloride ISE can now serve as a reference electrode with accurately known potential.

3. In the described cell, this now permits measurement of pH with the glass electrode and ORP with the platinum wire. The chloride concentration of the sample can of course also be reported.

There are limitations and variations to this concept as so far described. Some limitations are:

A. The sample must contain the ion that determines the potential of the ISE to be used as reference within a certain range.

B. The sample must be free of substances that interfere with the chosen ISE and chronopotentiometric determination of the target ion.

Some variations are:

i. The same electrode that is used as the chronopotentiometric working electrode can serve as the chloride ISE/reference, and the glass pH cell can be used as reference during chronopotentiometry, thereby reducing the required number of electrodes in the above example to three. The potential of a silver electrode, when coated with silver chloride, is determined by chloride ion concentration, yet can still serve as a chronopotentiometric working electrode for chloride determination.

ii. A silver-chloride-coated silver wire, for example, can therefore be used as an ISE to measure chloride (Embodiment 2), and thus serve as reference electrode after the chloride concentration is known and can still be used as working electrode in chronopotentiometry. Thus when the chronopotentiometric determination of chloride is complete, the circuitry switches from chronopotentiometry to potentiometry and the silver-chloride-coated wire can serve as the reference electrode for other measurements such as pH. A drawback or trade-off in this approach is that silver-chloride-coated wires are not as selective as most membrane-based chloride ISEs, or at least may have different selectivity with respect to other species in a sample.

iii. Likewise, by using the silver wire as both chronopotentiometric working electrode and chloride ISE/reference, and using the platinum wire simultaneously as counter and reference electrode for chronopotentiometry, the number of electrodes can be reduced to three, including the pH half-cell (Embodiment 3).

iv. Other ions that can be determined by chronopotentiometry, or other electrochemical techniques, and for which ISEs exist, provide the basis for other cells requiring no liquid junction. Examples in which a silver wire might serve as working electrode are bromide, iodide, thiocyanate, and sulfide.

The present invention will be further illustrated with reference to the following examples which aid in the understanding of the present invention, but which are not to be construed as limitations thereof. All percentages reported herein, unless otherwise specified, are percent by weight. All temperatures are expressed in degrees Celsius.

### EXAMPLE

The solid-state reference electrode concept of this invention is demonstrated in this example using the cell described as Embodiment 3.

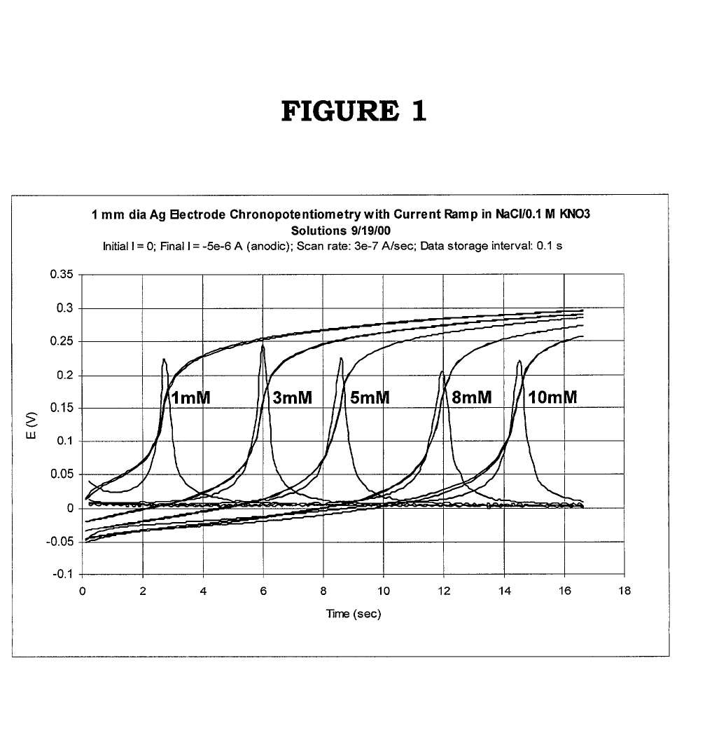

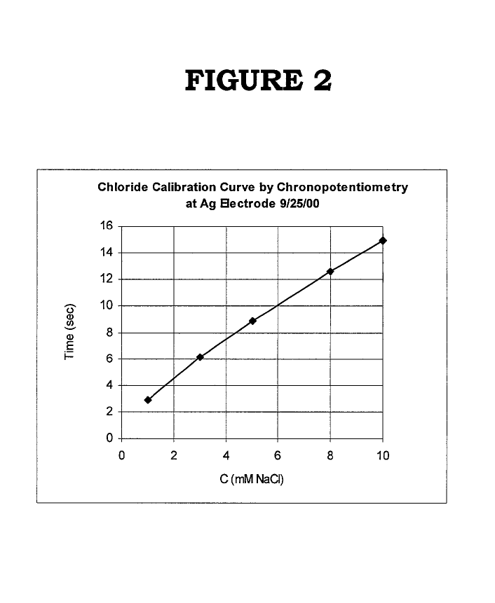

First, it is necessary to establish a calibration curve for the chronopotentiometric determination of chloride. FIG. 1 shows an example of chronopotentiograms and their first derivatives for 5 concentrations of chloride from 1 to 10 mM, each run twice. An anodic, linear current ramp from 0 to 5 μA in 16.67 sec was applied to the silver wire using the platinum wire as counter and reference electrode. FIG. 2 is a typical chloride calibration curve obtained by plotting against the chloride concentration the time elapsed to the chronopotentiometric inflection point as indicated by the maximum in the first derivative.

Next, the pH measurement is calibrated in a solution with known pH and chloride concentration. A form of the Nernst Equation can then be used for calculation of the pH in unknown samples:

$${E}_{Sample} = {E}_{Std} + {s}_{pH} \cdot ( {pH}_{Sample} - {pH}_{Std} ) - {s}_{Cl} \cdot log ( \frac{{Cl}_{Sample}}{{Cl}_{Std}} ) \qquad Eq 1$$

Where:

E_{Sample} is the potential of the pH half-cell vs the chloride half-cell in an unknown sample.

E_{Std} is the potential of the pH half-cell vs the chloride half-cell in a standard solution.

s_{pH} is the slope of the pH half-cell.

pHₛₐₘₚₗₑ is the pH of an unknown sample.

pH_{Std} is the pH of the standard solution.

s_{Cl} is the slope of the chloride half-cell.

Cl_{Sample} is the chloride concentration in the unknown sample.

Cl_{std} is the chloride concentration in the standard solution.

The equation can be re-arranged to solve for pHₛₐₘₚₗₑ:

$${pH}_{Sample} = \frac{( {E}_{Sample} - {E}_{Std} + {s}_{Cl} \cdot log ( \frac{{Cl}_{Sample}}{{Cl}_{Std}} ) )}{{s}_{pH}} + {pH}_{Std} \qquad Eq 2$$

In this example, the standard solution was a potassium hydrogen phthalate buffer containing 5 mmoles/L chloride and having a pH value of 3.981 at 20° C. The slopes of the pH and chloride half-cells were checked using standard pH buffers and chloride solutions, respectively, and were found to have approximately theoretical slopes of −58 mV/pH and −58 mV/log(Cl), respectively, at 20° C.

The table below shows the results of making pH measurements in four unknown samples using the cell of Embodiment 3 compared to a conventional pH cell with liquid junction reference. Samples were tap water and tap water to which small amounts of standard pH buffers were added in order to establish a range of sample pH values. Chloride concentration values in the unknown samples were determined by running chronopotentiograms and reading the chloride concentration from the calibration curve in FIG. 2.

pH values determined by means of the cell without liquid junction gave slightly lower values: differences of −0.16, −0.15, −0.12, and −0.12 were obtained respectively for the four samples. These results were considered very satisfactory as proof of concept and, indeed, would be satisfactory for many routine pH measurement applications. It is very likely that refinement of the technique could result in even better agreement between the cells described in this application and conventional cells. Calculations could be refined, for example, by taking into account such variables as activity coefficients, liquid junction potentials, and slight temperature variations. The measurement protocol could be refined, for example, by performing multi-point calibration of the pH/chloride half-cell combination.

Embodiment 3 Results

| | | | pH_{Sample} | | |
|---|---|---|---|---|---|
| | E_{Sample} | Cl_{Sample} | (cell of | pH_{Sample} | pH |
| Sample | (mV) | (mmoles/L) | Embodiment 3) | (conventional cell) | Difference |
| Tap water | −1.3 | 1.85 | 7.18 | 7.34 | −0.16 |
| Phosphate | 10.4 | 1.85 | 6.98 | 7.13 | −0.15 |
| buffer | | | | | |
| diluted 50x | | | | | |
| with tap | | | | | |
| water | | | | | |
| Borate | −101.4 | 1.79 | 8.89 | 9.01 | −0.12 |
| buffer | | | | | |
| diluted 50x | | | | | |
| with tap | | | | | |
| water | | | | | |
| Phthalate | 123.9 | 2.04 | 5.06 | 5.18 | −0.12 |
| buffer | | | | | |
| diluted 50x | | | | | |
| with tap | | | | | |
| water | | | | | |

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. An electrochemical cell comprising two or more electrodes wherein the half-cell potential of at least one electrode is determined by the concentration of a specific ion anticipated to be present in all test solutions, said ion concentration being measured in the cell by a first electroanalytical technique that does not depend on a known reference electrode potential, such that said electrode, its half-cell potential being calculable from the measured ion concentration, can thereafter serve as a reference electrode in one or more subsequent electroanalytical techniques that do depend on a known reference electrode potential, said subsequent technique or techniques being carried out in the same cell.

2. A cell as in claim 1, wherein the electrode with half-cell potential determined by a specific ion is a chloride ion-selective electrode.

3. A cell as in claim 2, wherein the ion that determines its potential is chloride ion, and the test solutions are either standardizing solutions of known composition or sample solutions of unknown composition, but where all said solutions are known to contain chloride ion.

4. A cell as in claim 1, wherein the first electroanalytical technique, that does not depend on a known reference electrode potential, is chronopotentiometry.

5. A cell as in claim 1, wherein one of the subsequent electrochemical techniques that does depend on a known reference potential is potentiometry.

6. A cell as in claim 4, wherein the working electrode is silver and the ion determined by chronopotentiometry is chloride ion.

7. A cell as in claim 4, wherein the silver working electrode, because the anodic deposition of chloride on the silver surface during chronopotentiometry renders that surface ion-selective for chloride, also serves as reference electrode for subsequent techniques.

8. A cell as in claim 5, wherein the measurement is selected from the group consisting of ORP, pH, or other measurements in which specific ions are the parameters measured by potentiometry.

9. An electrochemical cell comprising at least one ion-selective electrode, the potential of which is determined by the concentration of a specific ion, anticipated to be present in all test solutions, said ion concentration being determined in the cell by a first electroanalytical techniques carried out in the same cell.

10. A cell as in claim 9, wherein the electrode is a chloride electrode.

11. A cell as in claim 10, wherein the ion that determines its potential is chloride, and the test solutions are standardizing solutions or sample solutions all of which contain chloride ion.

12. A cell as in claim 10 or 11, wherein the technique for determining chloride is chronopotentiometry, the working electrode is a silver wire, and a chloride ion selective electrode serves as a reference electrode, the potential of which is initially unknown, but only until such time as the technique is completed, when the chloride ion concentration and therefore chloride electrode potential become known.

13. A cell as in claim 10, wherein the chloride electrode, its potential having been determined by chronopotentiometry, serves as reference electrode for a different electroanalytical technique.

14. A cell as in claim 11, wherein the different electrochemical technique is a direct potentiometric measurement such as pH, ORP, or other ISE measurement.

13. A cell as in claim 9, wherein the technique for determining chloride is chronopotentiometry and in which the chloride electrode serves as working electrode during chronopotentiometric determination of chloride.

14. A cell as in claim 13, wherein the chloride electrode, its potential having been previously determined, thereafter serves as the reference electrode for a second and different electroanalytical technique conducted in the same cell.

15. A cell as in claim 14, wherein the different electrochemical technique is a direct potentiometric measurement such as pH, ORP, or other ion selective electrode-based measurement.
